(19) United States
(12) Patent Application Publication
(10) Pub. No.: US 2015/0379887 A1
(43) Pub. Date: Dec. 31, 2015

(54) DETERMINING AUTHOR COLLABORATION FROM DOCUMENT REVISIONS

(71) Applicant: Hapara Inc., Redwood City, CA (US)

(72) Inventors: Lee Becker, Boulder, CO (US); Jan C. Zawadzki, Auckland (NZ)

(21) Appl. No.: 14/643,690

(22) Filed: Mar. 10, 2015

Related U.S. Application Data
(60) Provisional application No. 62/017,774, filed on Jun. 26, 2014.

(51) Int. Cl. G09B 17/00; H04L 29/06; G06F 17/30

(52) U.S. Cl. CPC G09B 17/003; G06F 17/30958; H04L 65/403

(57) ABSTRACT

A system and method for receiving literacy metrics for a plurality of authors, the literacy metrics being based on multiple revisions of a document performed by the plurality of authors. Analyzing the multiple revisions to identify interactions between the plurality of authors and providing for display a collaboration graph based on the interactions of the plurality of authors, is provided.

### CROSS-REFERENCE TO RELATED APPLICATIONS

The present application claims the benefit of U.S. Provisional Application No. 62/017,774 filed Jun. 26, 2014, the disclosure of which is hereby incorporated by reference herein in its entirety. The subject matter of this application is related to the subject matter of co-pending U.S. application Ser. No. ______, filed <DATE>, entitled “ANALYZING DOCUMENT REVISIONS TO ASSESS LITERACY”, by the same inventors as this application, and being assigned or under assignment to the same entity as this application, and to the subject matter of co-pending U.S. application Ser. No. ______, filed <DATE>, entitled “RECOMMENDING LITERACY ACTIVITIES INVIEW OF DOCUMENT REVISIONS”, by the same inventors as this application, and being assigned or under assignment to the same entity as this application, each of which applications are incorporated herein in their entirety.

### TECHNICAL FIELD

Embodiments of the invention relate generally to analyzing document revisions, more specifically, to a system and method for analyzing document revisions to identify and assess the contributions and behavior of an author.

### BACKGROUND

In a student-teaching environment, a student is assigned writing projects to assess the student's literacy skills. The assessment is often the responsibility of the teacher, however in some standardized testing environments it may be performed by automated grading software. Teachers and automated grading software often only analyze the student's final version of the writing project, but may not take into account the students contributions leading up to the final work product.

Many curriculum standards emphasize collaboration, perseverance and other non-literacy skills in addition to individual writing skills. Students' writing projects may include contributions from multiple authors over the course of an assignment or semester. The writing projects may be stored in a document control system that supports simultaneous student contribution and may store multiple revisions of the writing project. The document control system often tracks a vast amount of information, which may make it challenging for a teacher to assess the quality of the student's contributions and how well a student collaborates with others and other non-literacy aspects of student behavior.

### BRIEF DESCRIPTION OF THE DRAWINGS

The present invention is illustrated by way of example, and not by way of limitation, and will become apparent upon consideration of the following detailed description, taken in conjunction with the accompanying drawings, in which like reference characters refer to like parts throughout, and in which:

FIG. 1 is a block diagram illustrating an exemplary system in which embodiments of the present invention may operate.

FIG. 2 is a block diagram illustrating an exemplary server architecture illustrating an arrangement of components and modules.

FIG. 3 illustrates an example of a process flow amongst the components and modules.

FIG. 4 illustrates a series of document revisions associated with multiple revision episodes.

FIG. 5 illustrates a process flow for analyzing revisions to determine an author's literacy role.

FIG. 6 illustrates a process flow for recommending a learning activity based on document revision analysis.

FIGS. 7A and 7B is an example diagram illustrating, respectively, the collaboration of multiple authors.

FIGS. 8A and 8B are example visualizations that include chord diagrams representing the contributions of the authors to the readability and word count, respectively.

FIGS. 9A and 9B are example visualizations that include a bar chart and histogram, respectively, for representing the literacy metrics associated with multiple authors.

FIGS. 10A and 10B are example visualizations that illustrate a change in a selected literacy metric over a duration of time.

FIG. 11 is an example visualization that includes a chart illustrating a selected literacy metric (e.g., document sophistication) over the course of multiple revisions by multiple authors.

FIG. 12 is an example visualization that includes a graph representing the proportions of an author's contribution to a selected literacy metric.

FIG. 13 is a block diagram illustrating an exemplary system in which embodiments of the present invention may operate.

### DETAILED DESCRIPTION

Embodiments of the invention are directed to a system and method for analyzing document revisions to identify and/or assess author contributions. The contributions may be derived from a single author or multiple authors and may span one or more texts, which may include documents, blog posts, discussion forum posts, emails or other similar communication. When analyzing the text revisions the system may generate metrics that include textual metrics (e.g., word count, readability) and activity metrics (e.g., edit time, author interactions). These metrics may then be used for identifying author or cohort engagement or collaboration depth, recommending learning activities and providing visualizations to support other types of analysis.

The system may identify texts and revisions associated with a user by scanning a document storage. The system may then analyze the texts and revisions to determine a variety of metrics, which may be aggregated based on, for example, a group of authors (e.g., class of students or a school) or time duration (e.g., semester). The metrics may then be statistically analyzed (e.g., normalized) and used to determine how an author or group of authors are performing in comparison to their peers or norms and to suggest learning activities to increase the authors skills.

The system may also utilize the metrics to determine and display how the author(s) collaborate with one another. This may include comparing the revisions to determine which contributions were made by which author and identifying the literacy role of the author (e.g., writer, editor, commenter). This data may then be displayed using one or more visualizations, such as for example, chord diagrams, graphs, bar charts and/or histograms.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

Unless specifically stated otherwise, as apparent from the above discussion, it is appreciated that throughout the description, discussions utilizing terms such as “receiving”, “determining”, “creating”, “monitoring”, “measuring”, “calculating”, “comparing”, “processing”, “instructing”, “adjusting”, “delivering”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (non-propagating electrical, optical, or acoustical signals), etc.

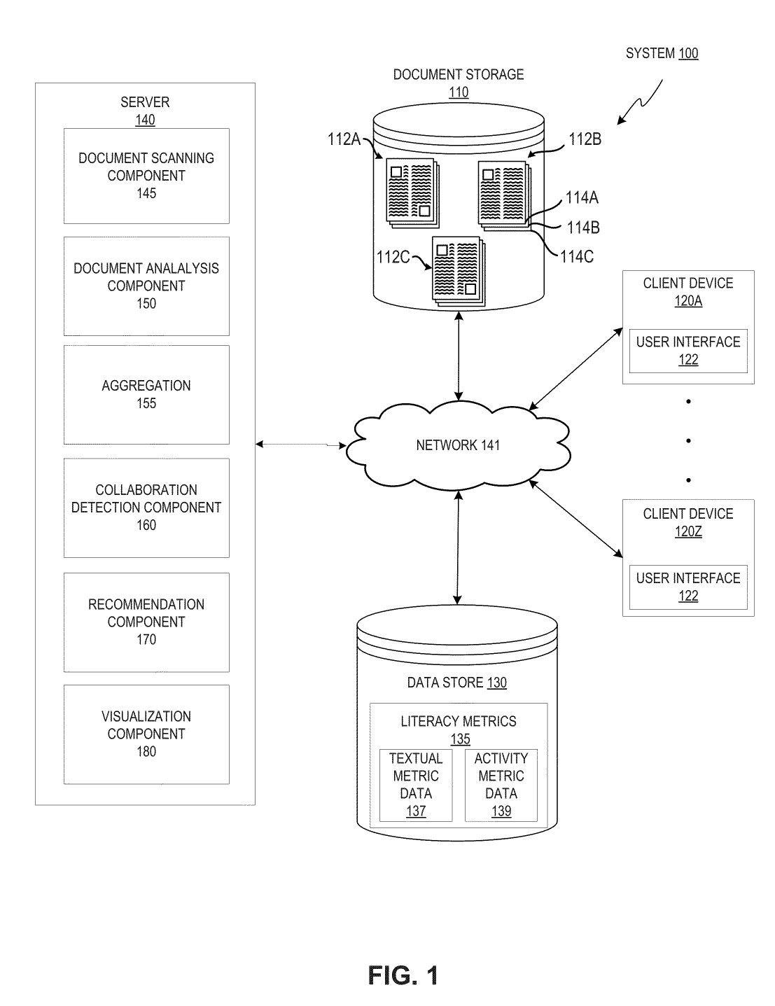

FIG. 1 is a block diagram illustrating an exemplary system 100 in which embodiments of the present invention may operate. Referring to FIG. 1, system 100 may be comprised of a document storage 110, a plurality of client devices 120A-Z, a data store 130, a server 140 and a network 141. Network 141 may comprise a private network (e.g., local area network (LAN), wide area network (WAN), intranet, etc.) or a public network (e.g., the Internet).

Document storage 110 may store multiple documents 112A-C and each document may include one or more revisions 114A-C. Document storage 110 may be remote from client devices 120A-Z and/or server 140 and may be accessed over network 150. In one example, document storage 110 may be a remote document storage accessible using network based communication, such as Hypertext Transfer Protocol (HTTP/HTTPS), File Transfer Protocol (FTP) or other similar communication protocol. The remote document storage may be hosted by a third party service that supports document collaboration (e.g., simultaneous editing), such as Google Drive, Office 365, or other similar service (e.g., cloud collaboration). In another example, the document storage may be stored local to server 140 or client devices 120A-Z.

Documents 112A-C may include text and may be stored in any object capable of storing text, such as blog posts, emails, discussion forum posts, documents such as Word, rich text, PowerPoint, Excel, open document format or other similar format. In one example, documents 112A-C may include essays, articles, books, memos, notes, messages (e.g., emails) or other similar text based writing.

Document storage 110 may also include multiple revisions corresponding to one or more documents 112A-C. Each of the revisions 114A-C may include modifications to the respective document 112A-C, such as for example, the deletion or addition of text. In one example, revisions 114A-C may comprise a series of edits that were performed to the document. As such, each revision may be delta encoded and may include only the changes from the version before or after it. In another example, each revision 114A-C may be a separate and complete version of a document (e.g., separate drafts of a work product), in which case the delta may be calculated by comparing the versions (e.g., executing a data comparison tool).

Client Device 120A-Z may include user interface 122 which may allow a user to interact with one or more other components. Interface 122 may enable users (e.g., authors, instructors) to collaborate in the creation of documents 112A-C on document storage 110. The interface may be a web browser or an application such as a word processor configured to access and/or modify documents 112A-Z. Interface 122 may also allow the users to access data store 130 to review document and/or user related literacy metrics.

Data Store 130 may include literacy metrics 135, which may comprise textual metrics 137 and/or activity metrics 139. Textual metrics 137 and activity metrics 139 may be forms of literacy metrics 135 and may be derived from text analysis. The metrics data may be specific to a single document, single revision or single author or may be aggregated across multiple revisions, documents and/or authors.

Textual metrics 137 may be derived using text analysis (e.g., natural language processing, computational linguistics) and may include word counts, part of speech counts, sentence types, spelling or grammatical errors, edit distance to earlier revision(s), semantic similarity, readability, sophistication scores, or other literacy related measure. A word count may include the total number of words or the quantity of words corresponding to a specific part of speech, such as, the number of nouns, pronouns, adjectives, verbs, adverbs, prepositions, conjunctions, interjections or other similar word types. The number of sentences may include the total number of sentences or the quantity of sentences corresponding to a specific sentence type, such as passive sentences, compound sentences, run-on sentences and/or similar grammatical classification. The number of errors may include the total number of errors, or the quantity of errors corresponding to a specific grouping, such as spelling or grammar mistakes (e.g., noun verb mismatch). Literacy metrics 135 may also include more advanced textual metrics that take into account the readability or sophistication of the document. In one example, this may include a numeric representation of readability of one or more documents, for example a Lexile Score.

Activity metrics 139 may also be a form of literacy metrics and may be derived from user behavior relating to reading and/or writing. Activity metrics 139 may include, for example, revision edit times, differences between revisions (e.g., edit distance), the number of times a user modifies a document (e.g., 5 times), how often a user edits a document (e.g., every two days), the duration of time the user edits a document (e.g., 30 min at a time), edit times in relation to document completion (e.g., night before assignment is due).

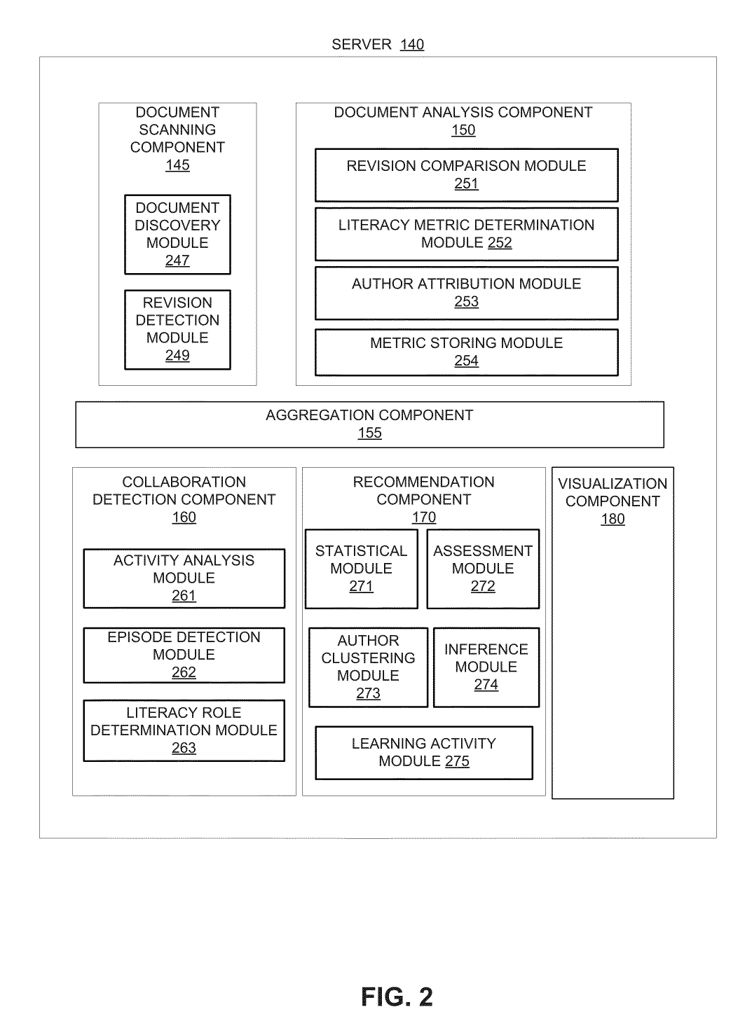

Server 140 may access and analyze documents 112A-Z to derive literacy metrics 135. Server 140 may include document scanning component 145, document analysis component 150, aggregation component 155, collaboration detection component 160, recommendation component 170, and visualization component 180. Document scanning component 145 may be configured to scan documents associated with a user to identify and locate documents modified by the user. Document analysis component 150 may be configured to process the modified documents to generate literacy metrics 135. Recommendation component 170 may be configured to utilize literacy metrics 135 to determine one or more learning activities for the author. Collaboration detection component 160 may also be configured to utilize literacy metrics 135 (e.g., activity metrics 139) to determine user behavior while authoring documents. Components of server 140 are further described with reference to FIG. 2.

FIG. 2 is a block diagram illustrating an exemplary server 140 in which embodiments of the present invention may operate. In one example, server 140 may include a document scanning component 145 and a document analysis component 150, which may function together as a data mining platform (e.g., text mining and metadata mining).

Document scanning component 145 may include a document discovery module 247 and a revision detection module 249. Document discovery module 249 may scan documents associated with one or more users to identify and locate documents created, accessed and/or modified by the users. In one example, scanning documents may involve executing a search of all documents associated with a set of users. In another example, document discover module 247, may include user customizable features that allow the scanning to be modified to search for documents having only a pre-determined type, (e.g., user or admin configurable) which may indicate a document has editable text, such as blog posts, emails, discussion forum posts or files with the following extensions: .doc, .ppt, .exs, .txt, rtf or other similar file type. In yet another example, document discover module 247 may scan documents with non-editable text, such as portable document formats (PDFs), in which case the component may perform or instruct another component to perform optical character recognition (OCR) to identify the text.

Revision detection module 249 may examine the documents discovered by document discovery module 247 to detect document revisions. Examining the documents may involve querying document storage 110 for revision information for a specific document. Examining the documents may also involve inspecting a document for embedded version data or track-changes information. In another example, the revision detection module 249 may inspect other documents associated with the user to detect similar documents, for example, it may search other documents in the same location (e.g., folder or directory) to locate a related document (e.g., early draft). Revision detection module 249, may also include a feature that allows for continuous analysis of files associated with the author, in which case it may pass along revisions as they occur (e.g., in real time).

When a document is identified, document scanning component 145 may inspect the location of the document within the organizational structure of document storage 110 to infer information associated with the document that may not otherwise be accessible from the document or the documents metadata. For example, the identified document may be associated with a folder and metadata associated with the folder may be inferred to apply to the document.

By extension, data storage 110 may be organized using a multi-level hierarchical data structure (e.g., tree structure) in which case information associated with ancestral levels (e.g., parent folder, grandparent folder) may be inferred to apply to a document found in a folder at a lower level. In one example, data structure may include a folder structure having N levels (e.g., 2, 3, 4 or more), wherein level 1 is the top level (e.g., grandparent folder) and level N is the bottom most level (e.g., child folder). For example, a folder at level 1 may correspond to a school, a folder at level 2 may correspond to an instructor at the school, and a folder at level 3 may correspond to a class for the instructor at the school. Thus, a document located within a class folder may be associated with the class and each of the ancestral levels including the instructor and school. In addition to the examples above, the levels of the hierarchical data structure may also correspond to any of the following information: district, school year, grade level, section, group, curriculum, subject and/or other similar grouping.

Document analysis component 150 may analyze documents 112A-C to generate literacy metrics 135 and may include a revision comparison module 251, a literacy metric determination module 252, an author attribution module 253 and a metric storing module 254.

Revision comparison module 251 may receive documents 112A-C from document scanning component 145 and these documents may have multiple authors and multiple revisions (e.g., revisions 114A-C). Revision comparison module 251 may process the revisions and identify which authors made which revisions as well as how and when the revisions were made. As discussed above the revisions may be stored as a series of delta revisions or as separate revisions (e.g., individual drafts of a document). When there are separate reversions, revision comparison module 251 may compare the revisions to determine the deltas, which may then be associated with the author that created the later revision. When the revisions are stored in a non-editable format (e.g., Tiff images or PDFs) the revision comparison module may have the revisions under-go optical character recognition (OCR) to make the text searchable prior to processing.

Determining who made the revisions may involve utilizing metadata associated with revisions. The meta data may be information that is accessed from the document storage or may be embedded within the document or revision, for example, some word processors may include features that store the author and date-time as metadata within the file (e.g., track-changes). Determining how the changes were made may include analyzing the editing behavior, for example, whether it was an additive change, a negative change (e.g., removing text) or whether the text was typed in or pasted in (e.g., cut-and-paste).

In a collaborative environment, the revision comparison module 251 may determine the differences between revisions (e.g., delta) to determine an authors contributions. Table 1 illustrates an example list of contributions, for ease of explanation these are based on non-negative revisions.

TABLE 1

| Revision | Word Count |
|---|---|
| 1 | 1300 |
| 2 | 350 |
| 3 | 500 |

As shown in Table 1, there are three revisions of a document, the first revision resulted in a document with 1300 words, the second revision resulted in a document with 350 words and the third revision resulted in a document with 500 words.

In one example, revision comparison module 251 may determine that a portion of the revisions (e.g., initial version) are based on contributions supplied by an instructor (e.g., teacher) and may distinguish or remove the contributions from the contributions of subsequent users (e.g., students).

Table 2 illustrates the computed deltas based on the revisions of Table 1. The choice of standard or non-negative delta calculations may depend on the final goal. For some use cases, such as when the goal is to quantify the total contribution, a non-negative delta may be appropriate, as seen in column two of Table 2. For tracking a literacy metric (e.g., readability, word count, or spelling errors) over the course of a writing project the standard delta calculation may provide a more accurate result.

TABLE 2

| Contributions | Absolute | Non-Negative Delta | Standard Delta |
|---|---|---|---|
| R2-R1 | 50 | 0 | −50 |
| R3-R2 | 150 | 150 | 150 |
| Total Contribution | 200 | 150 | 100 |

Literacy metric determination module 252 may receive revisions from revision comparison module 251, which may be specific to an author, time duration, and may process (e.g., natural language processing) them to identify their corresponding literacy metrics. The processing may begin with pre-processing steps, which may include text segmentation, language identification, grammatical tagging and/or other similar textual processing steps.

Text segmentation (e.g., tokenization) may include word, sentence, and/or topic segmentation. Segmenting text may involve identifying separator characters (e.g., tokens) that signify the beginning or end of a text group (e.g., word, sentence, paragraph, block, column, page). For word tokenization, the separator characters may include the space character, tab character, paragraph character and/or other similar whitespace characters. For sentence segmentation, the separator character may include periods, questions marks and/or other similar punctuations marks.

Language identification may comprise analyzing the metadata and/or text of the document. The metadata may be included within the document as a property field (e.g., document language field) or it may have been derived from the scanning discussed above (e.g., document within Spanish class folder). Identifying the language using the text may involve determining the character set used within the document (e.g., Russian characters) or it may involve analyzing the words of the text and comparing them to a language dictionary or language index.

Grammatical tagging may also be considered a part of document pre-processing and may include marking text, such as a word or group of words (e.g., phrase), as corresponding to a particular part of speech (e.g., preposition, noun, verb). The tagging may be based on computation linguistic algorithms, which may utilize statistical or rule-based modeling of natural language. In one example, it may analyze the definition of the text or the relationship of the text with adjacent and related text, such as related words in a phrase, sentence or paragraph, to determine the appropriate part of speech for the text and subsequently tag it as such.

During or after pre-processing the literacy metric determination module 252 may calculate literacy metrics 135. As previously described, the literacy metrics 135 may include counts for the various types of words and sentences. In one example, calculating literacy metrics 135 may occur after the pre-processing has annotated the text. In another example, the calculating step may be performed in parallel with the pre-processing steps.

In one example, the document processing may utilize a natural language processing toolkit to perform some or all of the text based processing. The natural language processing toolkit may include features similar to NLTK (Natural Language Tool kit), Stanford CoreNLP, ClearNLP, or other suite of libraries and programs for symbolic and statistical natural language processing. The natural language processing toolkit may utilize textual processing software such as, for example, Unstructured Information Management Architecture-Asynchronous Scaleout (UIMA-AS), General Architecture for Text Engineering (GATE), and/or other similar software.

Metrics storing module 254 may be a part of the document analysis component and may receive literacy metrics and organize and/or store them in document storage 110. Literacy metrics may be stored in a data store (e.g., relational database) and may be indexed using a key, which may be accessed by components or module executing on server 140 or on clients 120A-Z. In one example, the key may correspond to a user (e.g., author, instructor) and may be based on their user name, user ID (e.g., student ID). In one example, metrics storing module 254 may index the metrics based on author, document, time duration, or any other revision related data.

Aggregation component 155 may function to aggregate literacy metrics based on a variety of selected attributes. The attributes may include, one or more authors or author groups (e.g., class, grade, school, geography), time duration (e.g., semester, school year), literacy role, or other similar attribute. Aggregation component 155 may function as an interface between literacy metrics 135 obtained from the document revisions and components that may analyze and interpret this data such as, collaboration detection component 160, the recommendation component 170 and visualization components 180. Aggregation component 155 may allow the other components to add, remove and/or update literacy metrics 135.

In one example, aggregation component 155 may be configured to filter out certain types of information. The filtering may be done by rejecting certain document revisions or portions of document revisions based on certain editing behavior. For example, the system may filter out text that was cut-and-pasted by analyzing the text insertion rate (e.g., word insertion rate, character insertion rate). In one example, detecting the insertion rate may comprise computing a word-per-minute (WPM) rate for a revision by dividing the change in word count by the change in seconds, and then discard revisions that exceed a predefined word-per-minute threshold. This may be advantageous because gating inclusion of text derived from cutting-and-pasting may provide a more accurate assessment of student work. In another example, filtering may also include, for example, a filter that utilizes document classification to select only documents that are likely to include narrative texts. This latter filter may incorporate machine learning on a corpus of labeled documents to identify rules that eliminate revisions that conform to a non-narrative style.

Collaboration detection component 160 may be communicably coupled to document analysis component 261 through aggregation component 155 and may utilize literacy metrics 135 (e.g., activity metrics 139) to analyze how the users behave when editing the documents and with whom they interact. Collaboration detection component 160 may include an activity analysis module 261, an episode detection module 262 and a literacy role determination module 263. Activity analysis module 261 may access activity metric data 139 for one or more users. In one example, collaboration detection component 160 may access that information locally on the server 140 and in another example, this may involve querying a local or remote data store. Once the information is received, the metrics may be organized and transmitted to episode detection module 262 and literacy role determination module 263.

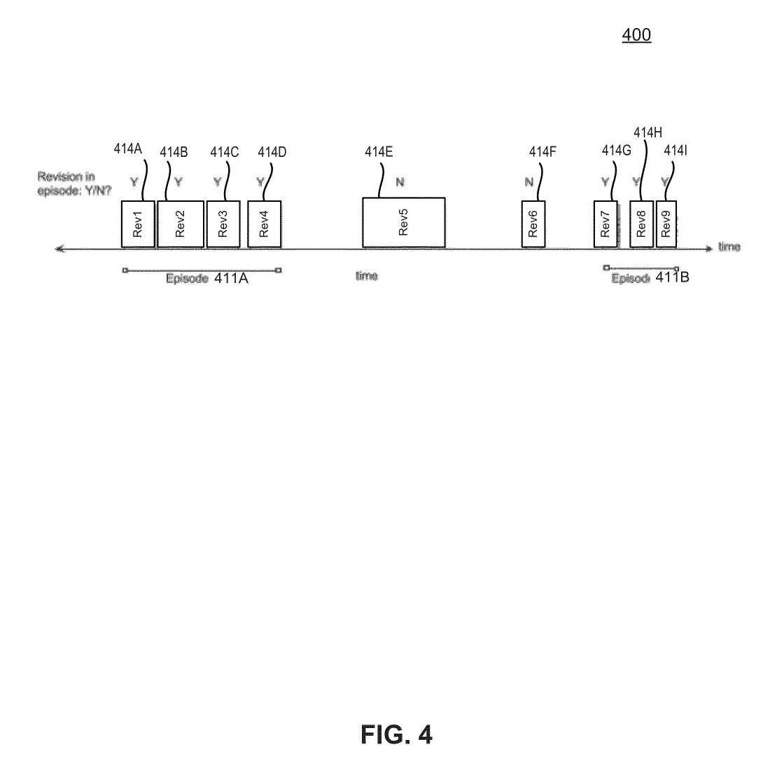

Episode detection module 262 may analyze activity metrics related to a user to detect one or more episodes of writing. For example, a document may include hundreds of revisions that span multiple months and the revisions may be grouped into one or more revision episodes. Each revision episode may identify semi continuous editing of the document, for example, an author may make several edits on one evening and then make several more edits on another evening. Episode detection module 262 is discussed in more detail with reference to FIG. 4.

Literacy role determination module 263 may analyze the literacy metrics to determine the literacy role that is most closely associated with the users function during the revision. In one example, the literacy role may comprise a label used to describe the author's contributions, for example, editor, commenter, writer, leader, scribe, organizer or other similar role. This label may be advantageous because it may allow an instructor to understand the various roles a user performs throughout a writing project. The literacy role may also be used when aggregating author contributions.

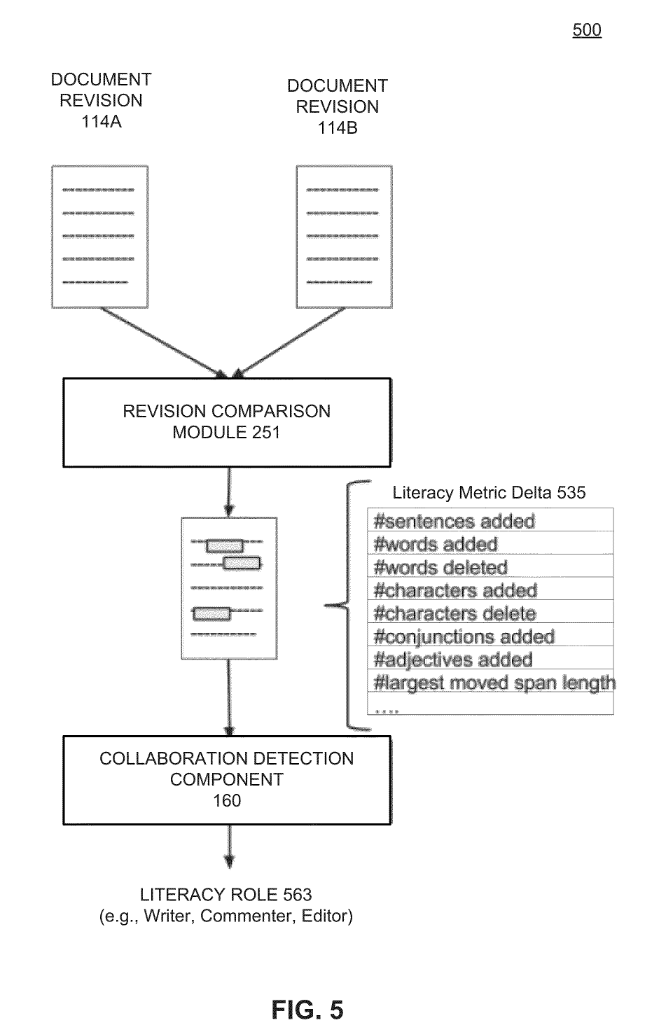

The literacy role may be implemented as a form of literacy metric data 135 that may be stored in data store 110. As shown here, literacy role determination 263 may be within collaboration detection component 160, however in another example it may be performed earlier in the process, for example, within document analysis component 150. Similar to the episode detection, the literacy role may be based on a set of rules and/or machine learning. Literacy role determination module 263 is discussed in more detail with reference to FIG. 5.

Recommendation component 170 may utilize the metrics generated by document analysis component 150 to assess an author and provide learning activities to enhance the author's literacy. In one example, literacy metrics are aggregated and normalized across the timespan of interest (e.g., semester, school year, all time) and activity recommendations are selected based on a rule based engine that weighs the normalized values.

As shown in FIG. 2, recommendation component 170 may include a statistical module 271, an assessment module 272, an author clustering module 273, an inference module 274 and a learning activity module 275. The statistical module 271 may receive literacy metrics 135 relating to multiple authors across multiple documents and may analyze the data to compute aggregated literacy metrics (e.g., combined statistical metrics) such as medians, averages, deviations and/or normalized data for individual authors and/or groups of authors. The aggregated literacy metrics may include multiple authors aggregated over classes, grades, districts, geographies, demographics or other groupings. In one example, this may involve generating a literacy model representing the author's competencies and the model may be continuously updated and may function as a predictive model to extrapolate future changes to a user's competencies.

Assessment module 272 may utilize the statistical data to assess the literacy of one or more authors. The assessment may function as a formative assessment that provides feedback information to assist authors understand their performance and their advancements. The assessment may also be used by instructors to identify and remediate an author or group of authors using learning activities, as well as to modify or updated the learning activities.

The assessment may include comparing the statistical data of the author with the statistical data of the one or more groups of authors, in which the author is a member. The comparison may be a multipoint comparison across multiple literacy competencies, in which case one or more metrics of the author may be compared to the corresponding aggregated literacy metrics of a similar group of authors. The similar group may be a group in which the author is or is not a member, such as the author's class or a different class. For example, the quantity of passive sentences drafted by an author may be compared to the corresponding average values for the author's class (e.g., statistical aggregated metric corresponding to passive sentences). In one example, assessment module 272 may function to analyze a subset of authors (e.g. class) and compare it to another subset of authors (e.g., class) at the same organization (e.g., school) or a different organization. In this example, the assessment module 272 may function to compare instructors, as opposed to just comparing individual authors.

Author clustering module 273 may analyze the literacy metrics and assessments of multiple authors and may cluster the authors into groups based on their competencies. In one example, this may include clustering multiple authors that struggle or excel with a particular literacy concept or a set of literacy concepts (e.g., passive sentences and present tense). The algorithm used by author clustering module 273 may be based on a similarity function such as Euclidean or Cosine distance in combination with a distance based clustering algorithm can be used to discover meaningful groupings of authors.

Inference module 274 may utilize literacy metrics data 263, assessment data and clustering results to identify links between competencies and infer an author's performance based on other similar authors. For example, it may determine that authors that struggle with a specific literacy concept also struggle with another concept. Inference module 274 may utilize machine learning to develop models for literacy prediction, which may involve using the literacy metrics data to identify links between the literacy concepts.

Learning activity module 275 may analyze literacy metrics and select or suggest one or more learning activities for the author(s). The learning activity may be performed by the author or may be performed by an instructor for the benefit of one or more authors. The learning activity may include, for example, lessons, resources, exercises, on-line and/or in-person demonstrations. The activities may assist an author to, for example, recognize a particular feature of a sentence (e.g., tense, noun/verb pairing).

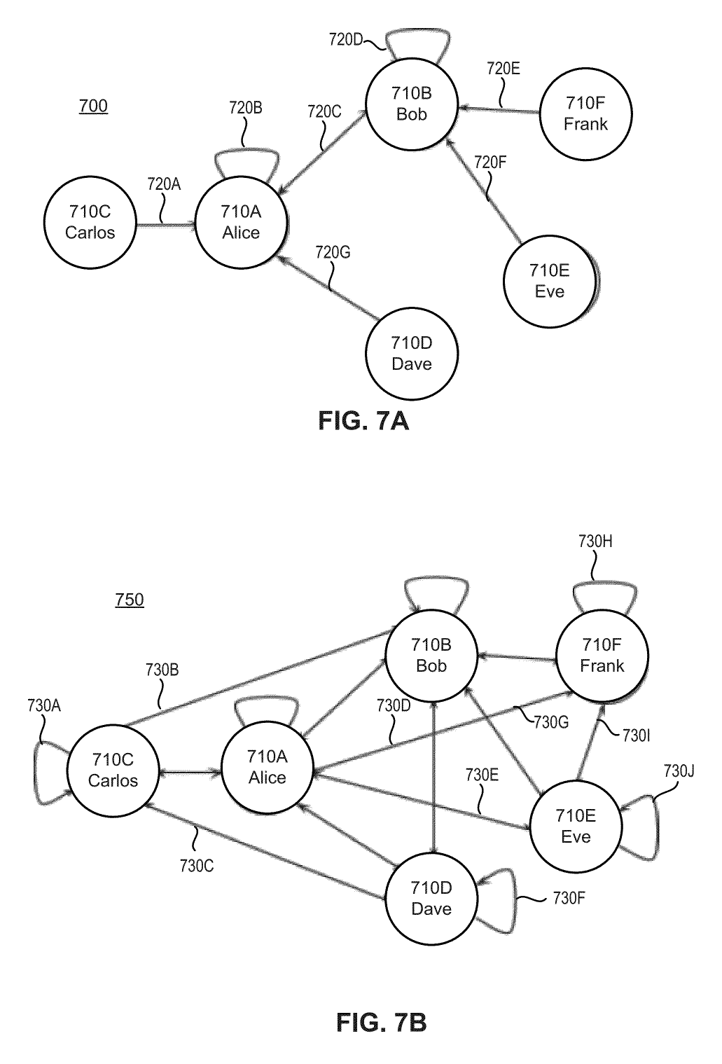

Visualization component 180 may provide a graphical representation of the data discussed above, such as literacy metrics, assessment data, clustering data, recommendation data, collaboration data. As discussed in more detail later with respect to FIGS. 7-12, the visualizations may include charts, chord diagrams, word counts, or other similar graphical representations.

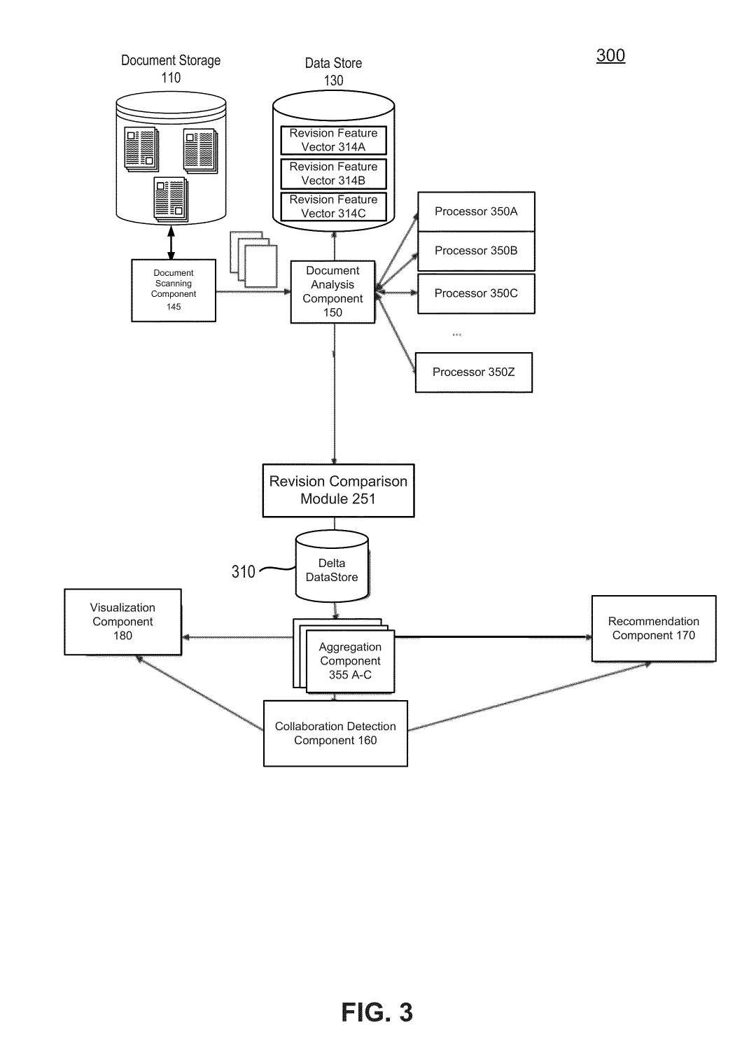

FIG. 3 is a schematic diagram that illustrates an example flow diagram of how the components and modules of server 140, as illustrated in FIGS. 1 and 2, discussed above may interact with one another to process document revisions for collaboration detection, recommendations and visualizations. FIG. 3 also illustrates the that the process may operate in a parallel and/or distributed manner and may utilize cluster, grid, or cloud based computing.

Referring to FIG. 3 document scanning component 145 may access documents stored in document storage 110. This may involve logging into a remote document storage (e.g., google drive) using credentials capable of accessing an author's documents, such as those of the author, instructor or administrator. The document scanning component 145 may also query remote document storage 110 to list out all of the documents associated with the user and record the list of documents and metadata associated with each document. The metadata may include any of the following: the creator, creation date/time, owner, read/write history, and any revision information. The revision information may include the content, author and/or data and time of each revision.

This information may be forwarded to document analysis component 150, which may distribute and parallelize all or a portion of the analysis steps. The document analysis component 150 may include a central administrative process for overseeing the processing of document revisions (e.g., dispatcher). The administrative process may distribute jobs to multiple document processors 350A-Z. Each job may range in complexity, for example, it may include processing a single revision, a single document with one or more revisions, all document relating to an author and/or all document for a group of authors (e.g., class). In one example, document analysis component 150 or server 140 may utilize an underlying software framework to handle the parallel and/or distributed processing, such as Hadoop's MapReduce or BigQuery.

Document processors 350A-Z may include functionality of the document analysis component discussed above and may process the revisions and return analysis such as linguistic annotation, revisions data, literacy metrics and statistical data. In one example, the revisions may be distributed and/or processed chronologically by incrementing revision-by-revision. The returned data may include counts as well as more complex measures of text, such as readability or sophistication. In some cases, the data may be used as proxies for curricular standards.

The data returned from the revision processors may be used to generate and/or update revision feature vectors 314A-C. A revision feature vector may be a data structure (e.g., internal or proprietary data structure) for storing information related to a revision such as the analysis data pertaining to that revision. In one example, a document revision feature vector may include one or more of the following members: an ID for the previous revision for the document, an ID for the next revision for the document, a list of metrics 1-N.

Revision feature vectors 314A-C may also be used by the revision comparison module 251 to compute the differences between feature vectors for subsequent document revisions. These differences may then be stored in data store 130 for subsequent access by another component such as aggregating component 355A-C.

Each instance of aggregating component 355A-C may interact with a different analysis component, for example, aggregating module 355A works with visualization component 180, aggregating module 355B works with collaboration detection component 160 and aggregating module 355C works with recommendation component 170.

FIG. 4 is an example graph illustrating multiple episodes, which may have been identified using episode detection module 262. FIG. 4 includes a time line graph 1300, episodes 1311A-B and revisions 1314A-I. The time line graph illustrates the revision history and may represent the duration of time documents 112A-C are being revised, in one example, this may span a week, month, semester, school year or other similar duration of time. Revisions 1314A-I may represent contributions of multiple authors to one or more documents related to a single writing project.

Episodes 1311A-B may comprise a sequence or series of revisions that occur simultaneously or in close proximity to one another. Each episode may include one or more revisions, for example, episode 1311A may include revisions 1314A-D and episode 1311B may include revisions 1314G-I. Not all revisions need to be identified as being part of an episode, as can be seen by revisions 1314E and 1314F. This may occur if they are performed at a time that is remote from other revisions.

Determining which revisions are grouped together in an episode may involve multiple steps. One step may include receiving a revision history for a document that includes multiple revisions. Another step may include iterating through each revision and computing the duration of time between the selected revision and the revisions closest in time both before (e.g., previous edit) and after (e.g., subsequent edit). The episode detection module 262 may then access the timing data (e.g., start time, end time, duration) and compare it (e.g., add, subtract) to determine the duration of time between the revisions. The duration of time is typically a positive value but may be zero or a negative value when the revisions occur simultaneously, as shown by overlapping revisions 1314A-B and 1314C-D.

In one example, the durations of time may be determined using revision feature vectors 314A-C, wherein a revision feature vector (e.g., 314B) may include pointers to the revision feature vector that occurred in time (e.g., 314A) and the revision feature vector that occurred in time (e.g., 314C). In another example, each revision feature vector may include a data entry to store the creation times of the previous and subsequent revisions or the duration of time between the previous and subsequent revisions, which may have been populated by the revision comparison module 251.

Once the time durations between revisions have been determined, the episode detection module 262 may compare the duration of time with a threshold value to determine if the one or more revisions should be part of an episode. In one example, the threshold value may be a predetermined duration of time (e.g., a few hours or a day) or the threshold may be dynamically calculated based on, for example, the median revision time between some or all of the revisions. In another example, episode detection may also be based on natural language processing or density detection. The natural language processing may include classifiers that utilize Chunking, such as Begin-Inside-Outside (BIO) Chunking. A chunking classifier may employ supervised machine learning or may utilize unsupervised machine learning.

Detecting revision episodes may be advantageous because it may assist with assessing an author's work in a group settings and provide more details about the nature of the collaboration. Episodes may enhance the ability to detect when multiple revisions between multiple group members occur within a compact time window demonstrating a highly collaborative episode. On the other hand, it can also detect when there is less collaboration by detecting when the revisions occur more asynchronously, in which case an author may make changes and provide it to another author to make subsequent changes.

Revision episodes 1311A-B may also be used to support rewarding or discounting revision behaviors. In one example, an instructor (e.g., teacher, mentor, cohort, colleague) may configure the revision based literacy analytics to provide more credit for collaboration than for solo work or vice versa. This credit may be assessed by providing revision weighting. The revision weighting may be a fixed weight per revision based one or more literacy metrics values or it may be based on an exponential decay function. The exponential decay function could be used to reward edits made in close proximity to one another while still granting credit for edits that are spaced away from episodes. The weighting coefficient may be computed with the below formula, wherein t and τ are the times to the current and last revisions respectively and W is a constant factor:

w=We^{t-τ}

FIG. 5 is an example method 500 for determining a literacy role of an author, which may be performed by a combination of document analysis component 150 and collaboration detection component 160. Method 500 includes document revisions 114A-B, revision comparison module 251, literacy metric delta 535, collaboration detection component 160 and literacy role 563.

Document revision 114A-B may represent two revisions of document 112A of FIG. 2. In one example, each revision may be a version of the document and may include the textual content of the document version. In another example, each revision may represent a document revision feature vector, which may include the metric related to each revision without including all of the textual content of the document version.

Revision comparison module 251, which is discussed above with respect to document analysis component 150, may receive document revisions 114A-114B and compare them to determine literacy metrics delta 535. literacy metrics delta 535 may include changes (e.g., additions, deletions) in the number of sentences, words, characters, symbols, conjunctions, adjectives, readability, largest moved span of text and/or other related literacy metrics type data.

Based on literacy metrics delta 535, collaboration detection component 160 may determine the literacy role 563 (e.g., writer, commenter, editor). In one example, the collaboration detection component 160 may utilize a rule-based system to map between literacy metrics delta 535 and literacy role 563. The rules may take into account the quantity of changed words and sentences and compare it with the quantity of new words and sentences. When the difference or ratio between these exceeds a predetermined threshold, such as ratio X:1, wherein X is 1, 3, 5, 7 or similar value, the literacy role may be considered an editor. In one example, the rules may be designated by an instructor, school administrator, or education committee. In another example, a machine learning classifier (e.g., decision trees, support vector machines or logistic regression) may be used to determine the rules using a labeled corpus of revisions. Once literacy role 563 has been determined, it may be associated with or incorporated into the corresponding revision feature vectors.

Determining the literacy role may be advantageous because it may enable filtering or aggregating revisions by role, which may allow author assessment to be more informative. For example, the literacy role may allow the system to quantify the number of past-tense sentences produced as a writer or addressed as an editor. It may also be used to quantify how many minutes the user spends writing verses how much time is spent revising. For a group project, it may be used to determine how much time each author spent performing a set of roles. (e.g., writer, editor, commenter). It may also enable a collaboration ranking within a group of authors (e.g., class) for a specific role.

As discussed above with respect to revision episodes, the literacy roles may also be used for discounting or for weighting user contributions. In one example, an author performing revisions in the writer role may be provided full credit (1.0), whereas an author performing revisions as an editor or commenter may receive half-credit (0.5) or one-tenth (0.1) respectively. The credits may then be aggregated across all revisions and/or episodes of authoring and a weight adjusted metric of work may be obtained. The literacy roles may be determined on a per-revision basis, which may allow for sequence mining of literacy roles. This may be advantageous because it may allow an instructor to identify patterns of writing. As seen in the below table, there is a sequence of revisions 1-8, and each revision is associated with different literacy role.

TABLE 3

| Revision | Literacy Role |
|---|---|
| Rev. 1 | Writer |
| Rev. 2 | Writer |
| Rev. 3 | Editor |
| Rev. 4 | Commenter |
| Rev. 5 | Editor |
| Rev. 6 | Editor |
| Rev. 7 | Commenter |
| Rev. 8 | Writer |

With a large collection of document revision histories and corresponding literacy roles, models can be trained to cluster similar sequences or to discover meaningful, recurring subsequences, which can later be correlated with human judgments for automatic assessment of a writing sequence. Some possible approaches include: (1) similarity by sequence edit distance; (2) Sequence motif model via expectation maximization; (3) Learning hidden node representations via techniques used for deep-learning language modeling.

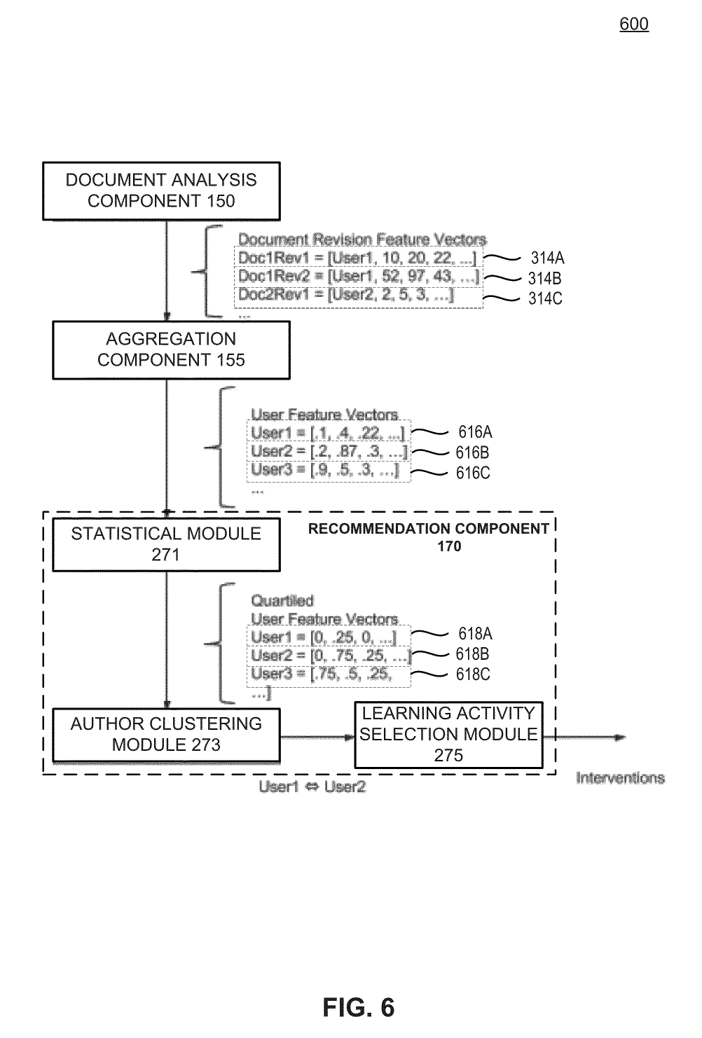

FIG. 6 includes a flow diagram illustrating the processing associated with generating a learning activity recommendation. The learning activity recommendation may involve document analysis component 150, aggregation component 155 and recommendation component 170, which may include a statistical module 272, an author clustering module 273 and learning activity selection module 275. Document analysis component 150 may analyze multiple revisions of a document and generate document revision feature vectors 314A-C. Each of feature vectors 314A-C may be associated with a single document (e.g., Doc1) and a single author (e.g., User1). The feature vector may also include multiple numerical values corresponding to the literacy metrics associated with the document revision.

Aggregation module 155 may analyze revision feature vectors 314A-C and aggregate them into user feature vectors 616A-C. Each user feature vector may correspond to a single user (e.g., author) and may include literacy metrics that span multiple revisions from one or more documents. The literacy metrics stored in the user feature vectors may include a total metric value (e.g., summation), an average metric value, or other aggregated measure.

Statistical Module 271 may analyze the user feature vectors generated by aggregation component 155 and normalize them to generate quartiled user feature vectors 616A-C. The process of normalizing user feature vectors 616A-C to produce quartiled user feature vector 618A-C may comprise iterating through the literacy metrics of the user feature vectors and adjusting the literacy metric values to align with a common scale. This may include bringing the probability distributions of adjusted values into alignment with a normal distribution (e.g., bell curve). The normalization may be quantile normalization, wherein the quantiles of different measurements are brought into alignment. Quantile-normalization may involve using a test distribution to a reference distribution of the same length, sort the test distribution and sort the reference distribution. The highest entry in the test distribution then takes the value of the highest entry in the reference distribution, the next highest entry in the reference distribution, and so on, until the test distribution is a perturbation of the reference distribution. To quantile normalize two or more distributions to each other, without a reference distribution, sort as before, then set to the average (e.g., arithmetical mean) of the distributions so the highest value in all cases becomes the mean of the highest values, the second highest value becomes the mean of the second highest values, and so on. In one example, the reference distribution may be a standard statistical distributions such as the Gaussian distribution or the Poisson distribution, however, any reference distribution may be used. The reference distribution may be generated randomly or derived from taking regular samples from the cumulative distribution function of the distribution.

Each quartiled user feature vector 618A-C may correspond to a specific user (e.g., author) and may include literacy metric values that have been normalized. In one example, each literacy metric type (e.g., past tense usage, perfect tense usage) may be normalized independent of other literacy metric types and the resulting value may be a value between 0 and 1 (e.g., decimal or fraction) as seen in by user feature vectors 616A-C.

Author clustering module 273 may utilize the quartiled user feature vectors 618A-C to cluster users with similar literacy skills (e.g., scores) into corresponding groups. The quartiled user feature vectors 618A-C may represent a set of literacy scores and may be used to identify similar users. One advantage of this is that it may assist in identifying a trends wherein users who need learning activities in skill X, may also need learning activities in skill Y.

Learning activity selection module 275 may use the nearest-neighbor metrics and suggest that users be provided learning activities based on the their nearest peers' quartile measures. For example, the below table shows the feature vectors for the four closest neighbors to User 4. Though User 4 scores in the 50% percentile in perfect tense usage, the recommendation component may suggest a learning activity to address this skill because his neighbors (based on feature vector similarity) fall in the bottom two quartiles. This approach can be further gated by randomly drawing with probability=1−user_quartile.

TABLE 4

| | Past | Perfect | | | |
|---|---|---|---|---|---|
| User/ | Tense | Tense | Progressive | Subject Verb | |
| Quartiles | Usage | Usage | Tense Usage | Agreement | . . . |
| User 1 | .75 | .25 | .25 | .25 | . . . |
| User 2 | .75 | .25 | .75 | .25 | . . . |
| User 3 | .75 | 0 | .5 | .5 | . . . |
| User 4 | .5 | .5 | .5 | .75 | . . . |
| User 5 | .5 | 0 | .25 | .5 | . . . |

FIGS. 7A-B include social node graphs that illustrate user collaboration data mined from the literacy metrics data of multiple document revisions. The literacy metrics 135 may include text metric data 137 and activity metric data 139 (e.g., behavior data) and may be represented by a social network. The pairing of literacy analytics with social networks may be advantageous because it may provide patterns of collaboration in writing and may be used for recommending learning activities.

Mining collaboration data may include one or more of the following steps: (1) extracting document revision metrics from a body of writing which may be performed by document analysis component 150; (2) Aggregating the metrics, which may be performed by aggregation component 155; (3) Extracting social graphs from revision data and computing graph based measures (e.g., centrality, pagerank), which may be performed by collaboration detection component 160; and (4) Presenting visualizations of graphs and graph measures, which may be performed by visualization component 180.

Extracting a social graph from the revision data may comprise identifying the revision owner and revision author based on the feature vectors or directly from the document revisions themselves. A creator/reviser pair can be used to define nodes and arcs in a directed social graph. When a document has more than two collaborators the graphs arcs can be built solely between creator/reviser pairs, or they can be distributed via transitivity between the author and all other authors and can be represented as either a unidirectional or bidirectional graph.

Referring back to FIG. 7A-B, graphs 700 and 750 include multiple nodes 710A-F and multiple arcs 720A-Q and 730A-J arranged in a network topology that represents the collaboration information presented in the below example table. Nodes 710A-F represent users and the arcs 720A-Q and 730A-J represent interactions amongst users, such as for example, a user revising text that was created by another user. Each arc originates at the user that made the revision and points to the user that created the text. In some situations, the arc may be bidirectional as seen by arc 720C which may indicate the existence of two arcs pointing in both directions. As seen in the below table, revisions d1r1-d1r4 were made by Alice, Bob, Carlos and Dave respectively and affected text created by Alice. This is illustrated in FIG. 7A because nodes representing Alice, Bob, Carlos and Dave (i.e., 710A-D) include arcs pointing to the Alice node. For example, arc 720B illustrates Alice revising her own text because the source of the arc (e.g., reviser) and the destination of the arc (e.g., creator) are both the Alice node (e.g., 710A).

TABLE 5

| Document | Text | Text |
|---|---|---|
| Revision | Creator | Reviser |
| d1r1 | Alice | Alice |
| d1r2 | Alice | Bob |
| d1r3 | Alice | Carlos |
| d1r4 | Alice | Dave |
| d2r1 | Bob | Bob |
| d2r1 | Bob | Alice |
| d2r2 | Bob | Eve |
| d2r3 | Bob | Frank |

FIG. 7B is similar to FIG. 7A and includes the same nodes and arcs, however it also includes arcs 730A-J which represent the added connectivity (e.g., arcs) when applying transitivity between all document collaborators. Transitivity extends one author's contributions to other authors associated with the author, for example, to other team or project members.

While the above Creator-Reviser data may be used to derive the network topology of a collaborative social network, as illustrated in graphs 700 and 750, the actual values or weights of the graph are derived from the literacy metric values. Summing weights across multiple writing projects (e.g., assignments) provides a graph with a large view of the behaviors exhibited in collaborative writing. The social graph allows collaboration to be measured along different dimensions of competency represented by the metrics/weights. Graph-theoretic measures of centrality such as page rank or degree centrality provide a means for quantifying and comparing user's collaborativeness (e.g., student, teacher, parent). The centrality numbers in turn can be used to track the authors' collaboration. The collaboration data extracted via the methods described above can be used to create a variety of visualizations (e.g., social-graphs).

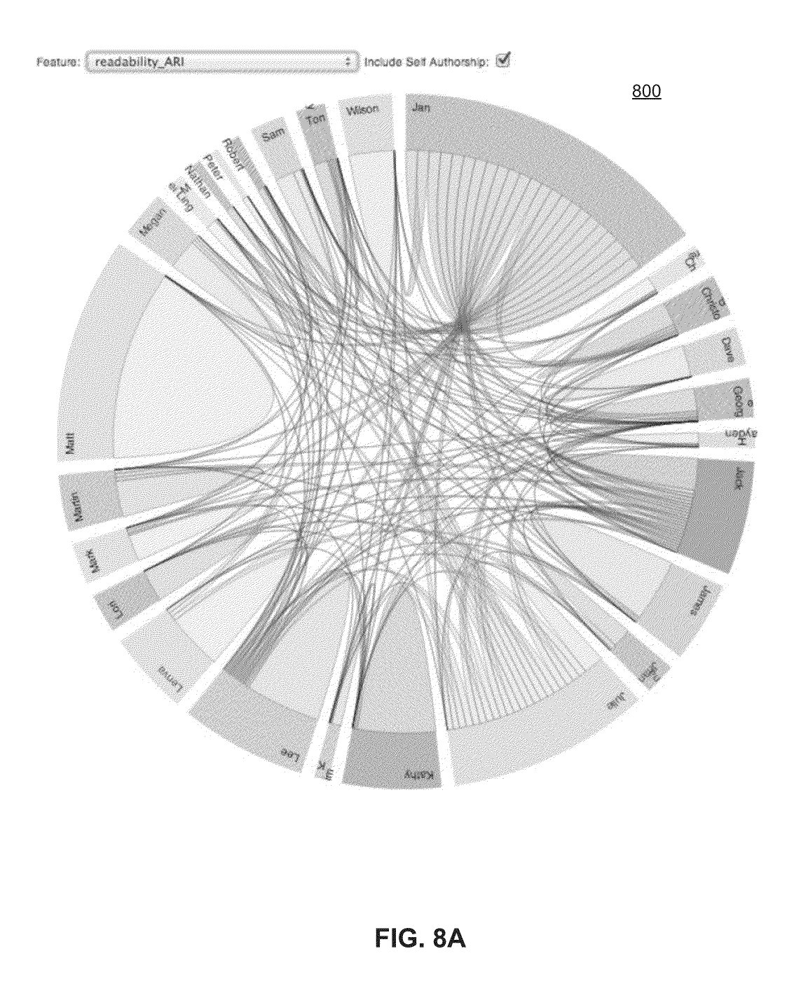

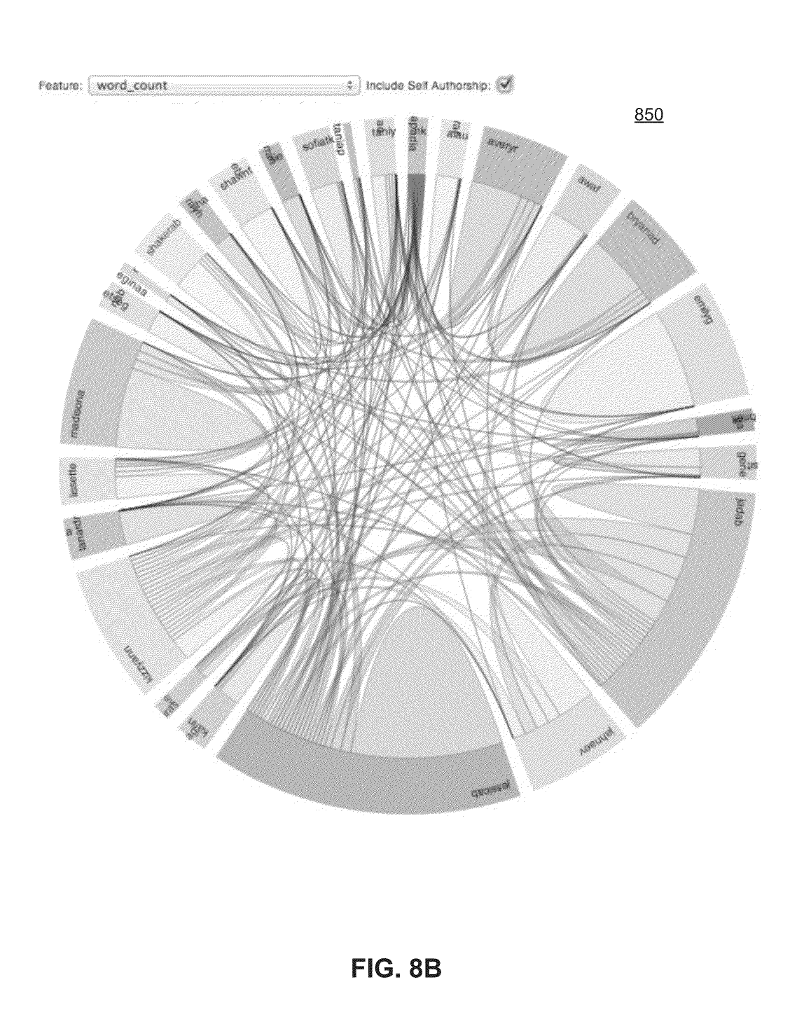

FIGS. 8A-B include example visualizations 800 and 850 for representing the aggregated work of an author along with Creator-Reviser pairings, which may enable a viewer to better understand how users work together (e.g., clique detection). As shown in FIG. 8A visualization 800 user (e.g., instructor) may use readability metrics and the collaboration data to visualize which authors improve the documents readability when collaborating with others. FIG. 8B on the other hand may represent just the word count contributions, as opposed to the readability of the words, for each user within a single classroom.

Visualizations 800 and 850 may comprise chord diagrams for representing the literacy metrics. The chord diagrams are graphical methods of displaying the inter-relationships between literacy metrics. The users name may be arranged radially around a circle with the relationships between the users being represented as arcs connecting the users. The portions of the circles circumference that is dedicated to a user may be proportionate to the user's metric value (e.g, word count, readability). For example, in visualization 800 user 850 occupies approximately a 45° portion of the circular circumference. Being that visualization 850 is based on the word count, as indicated by the selection of the “word_count” feature, this may illustrate that the user contributed 12.5% of the total word count. This is based on the fact that 360° equates to total words contributed to the document, thus 45° would equate to 12.5% of the total circumference.

The arcs connecting the users represent their relative contributions to each others' documents. For example, if two authors contribute to each other's documents equally the arc will have the same width on each user. If there is a disparity, the user who contributes more will have an arc with a wider base on his/her end. The width of the arc is also scaled relative to the user's total contribution within a group of authors. The quantity of arcs associated with the portion graph edges and weights may be used to visualize student contributions and collaboration. The same visualization may be expanded for any revision based activity or literacy metric such as time, revision count, number of sentences written in the passive voice or even readability metrics (e.g. Flesch Kincaid) or other similar literacy metric.

In addition to the chord diagrams there are many other types of graphical representations that are useful to for representing student assessment, activity and collaborations, below are a few possible options within the scope of this disclosure.

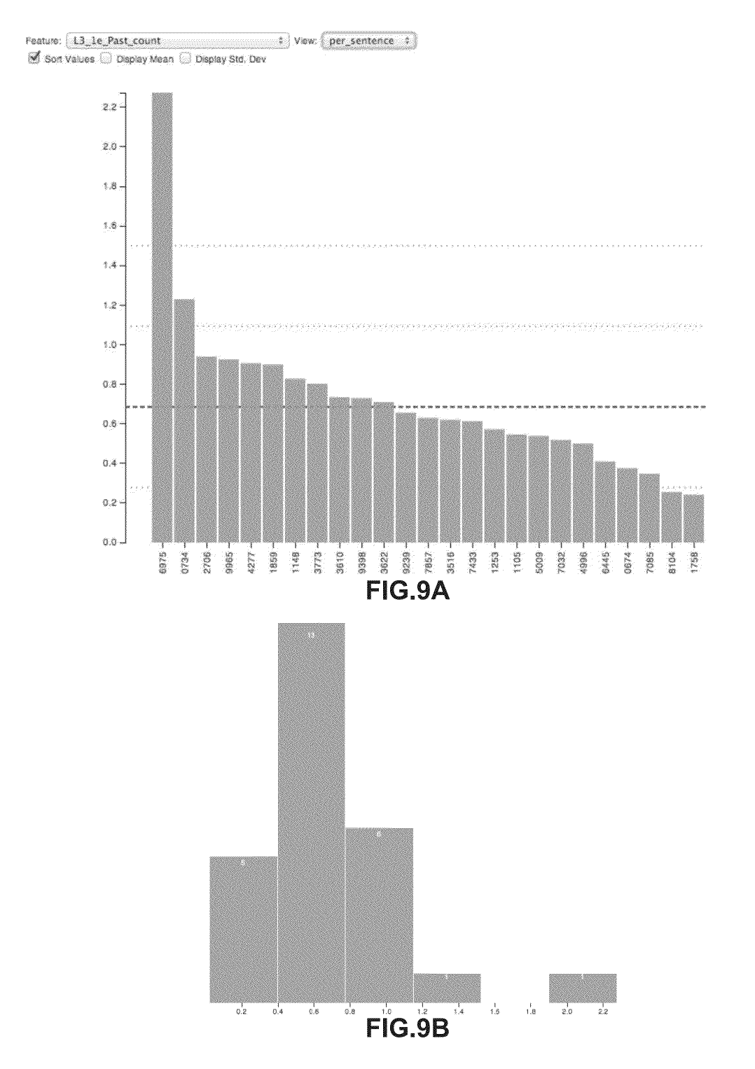

FIGS. 9A-B illustrates some example visualizations for literacy metrics and may help the viewer to understand distribution of literacy metrics (e.g., averages, norms) across different populations and demographics. FIG. 9A illustrates student usage of past tense verbs per sentence and FIG. 9B is a histogram showing the distribution of these values across a classroom, which may be computed by summing metrics across all contributions.

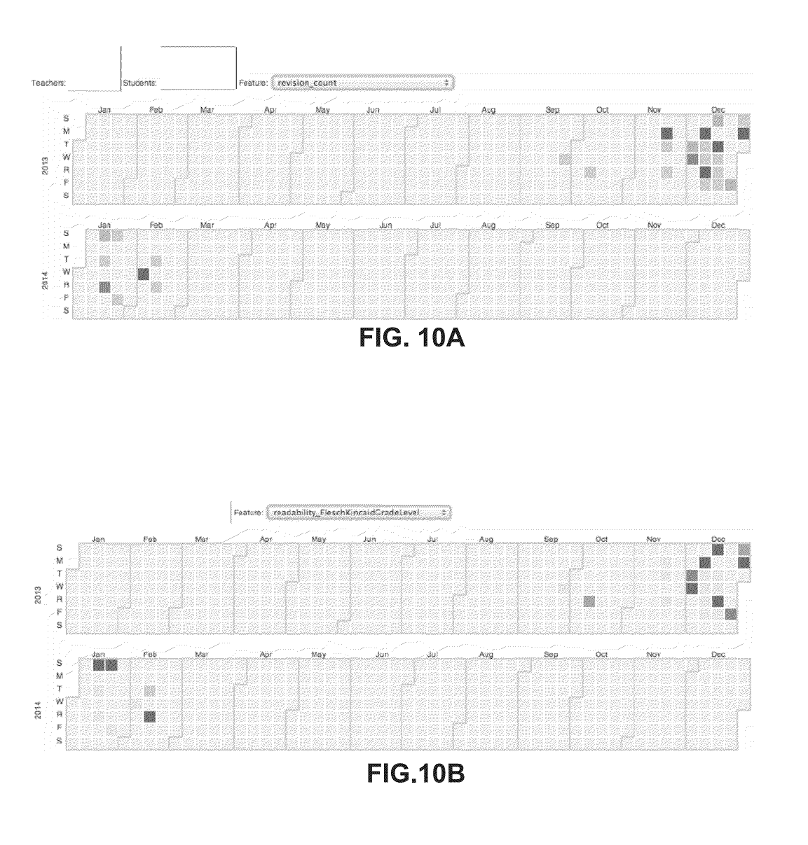

FIGS. 10A-B illustrate example time based visualization that utilizes the timing data (e.g., timestamps) associated with the literacy metrics information. the literacy metrics are aggregated (e.g, averaging, summing) by some time quanta (e.g., hour, day, month or some range or similar time duration). As shown in FIG. 10A, the revision counts are being displayed on a yearly calendar and each little square represents a day and the darker the square the more revisions were made during that period of time.

FIG. 10B is similar to FIG. 10A, however it displays the readability level of the resulting document. This may include summing the contributions of multiple authors and assessing from day to day the resulting document using the Fleisch Kincade Reading Level metric charts. Days with dark shades mean the student's contributions were at a higher reading level than on days with lighter shades. In alternative examples, the shading may correspond to transitions in color (green to red), transparency, brightness or other similar mechanism. This kind of visualization may be adapted for any of the literacy metrics produced by the system.

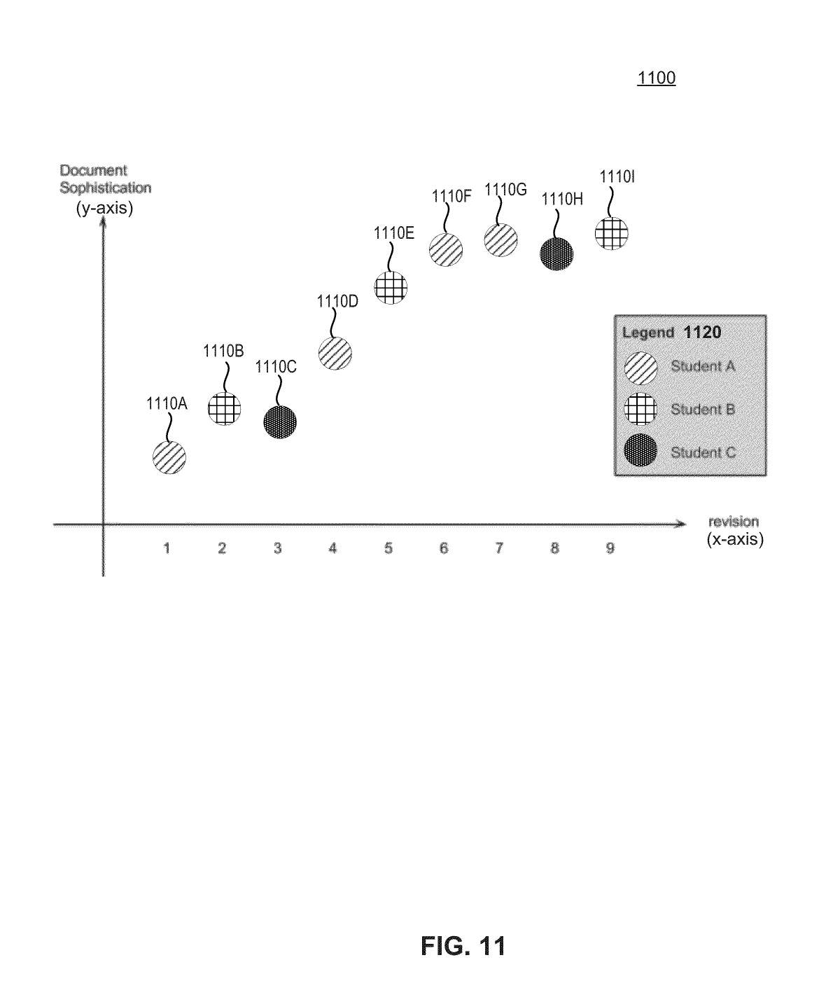

FIG. 11 is an example visualization that illustrates variations in literacy metrics over a series of revisions. As shown in FIG. 11 there is a graph 1100, with points 1110A-I representing multiple revisions. The graph's x-axis lists the revisions in chronological order and the y-axis is the document sophistication score value. As shown by legend 1120, there are three authors involved in the set of revisions, namely student A, student B, and student C. Revisions 1110A, D, F and G are associated with student A; revisions 1110 B, E and I are associated with student B; and revisions 1110C, and H are associated with student C. One advantage of visualization 1100 is that it allows a viewer to see, for example, that each contribution by student C decreases the overall sophistication score of the document. In which case, a learning activity may be appropriate for student C.

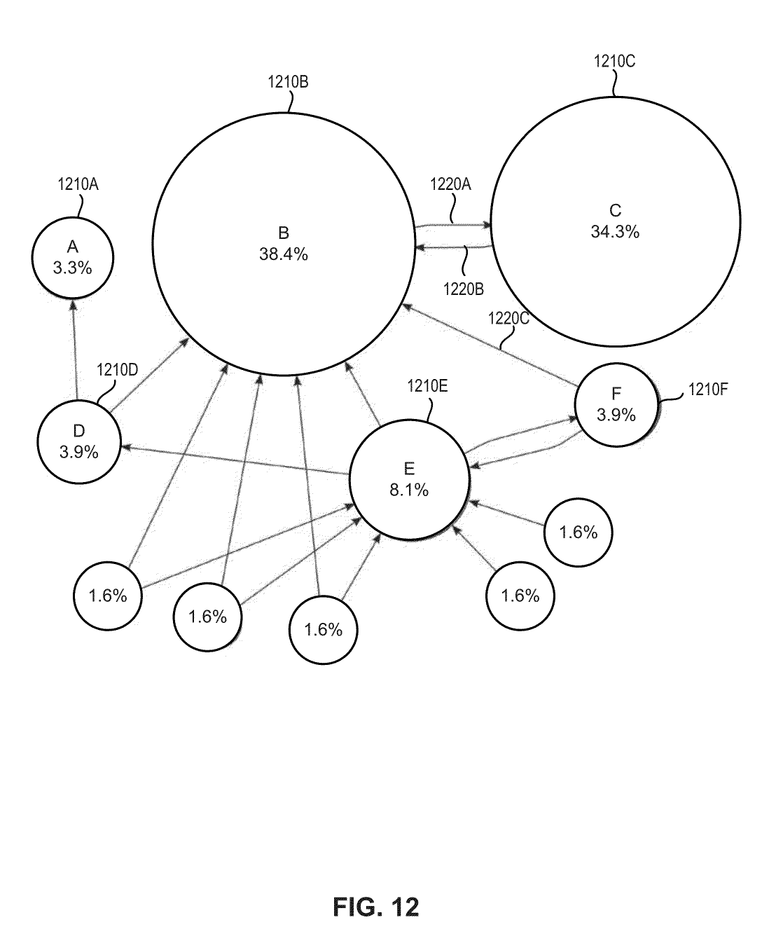

FIG. 12 is an example of a visualization that illustrates the collaboration ranking of various literacy metrics (e.g., word count, spelling errors, readability). Collaboration ranking may include comparing the contributions of an author to other authors that contributed to the same document or set of documents. FIG. 12 comprises nodes 1210A-K and arcs 1220A-C, which each represent a user that has modified a document. The size of the node (e.g., area, diameter, radius, circumference) may be proportionate to the contribution of the user. For example, the student represented by node 1210B, has contributed 38.4% of the total amount of the total literacy metrics, so if it was selected literacy metric was word count, the user has contributed 38.4% of the total word count of a document.

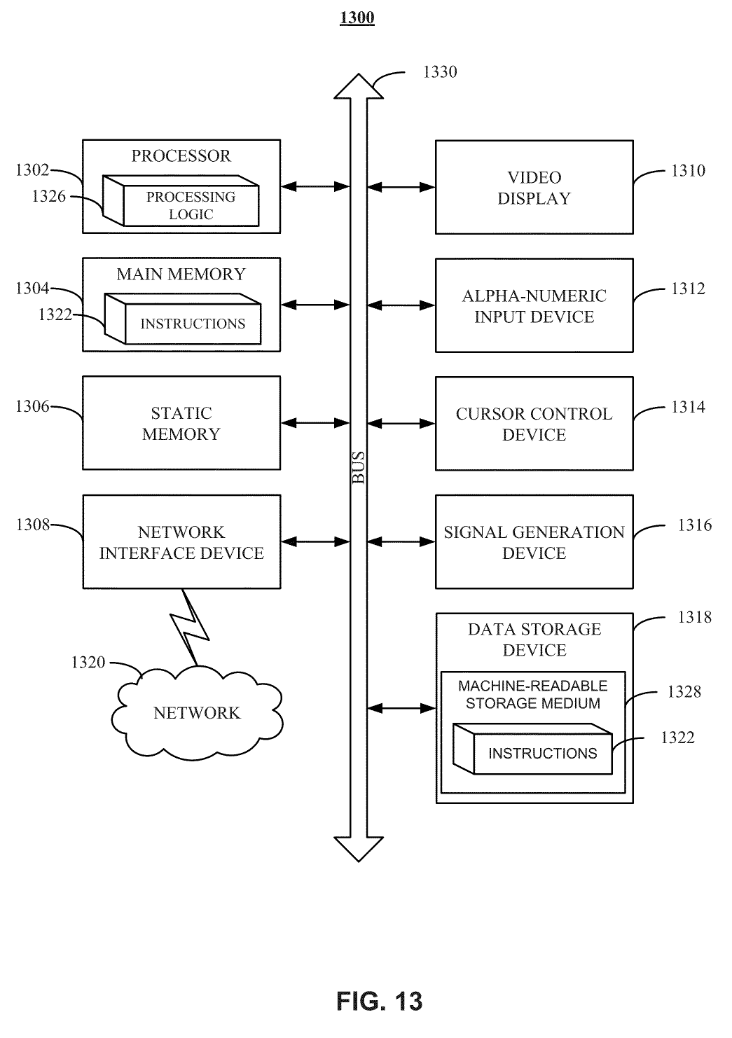

FIG. 13 illustrates a diagrammatic representation of a machine in the exemplary form of a computer system 1300 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1300 may be comprised of a processing device 1302, a main memory 1304 (e.g., read-only memory (ROM), flash memory, dynamic random access memory (DRAM) (such as synchronous DRAM (SDRAM) or Rambus DRAM (RDRAM), etc.), a static memory 1306 (e.g., flash memory, static random access memory (SRAM), etc.), and a data storage device 1318, which communicate with each other via a bus 1330.

Processing device 1302 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1302 may also be one or more special-purpose processing devices such as an application specific integrated circuit (ASIC), a field programmable gate array (FPGA), a digital signal processor (DSP), network processor, or the like. Processing device 1302 is configured to execute processing logic 1326 for performing the operations and steps discussed herein.

Computer system 1300 may further include a network interface device 1308. Computer system 1300 also may include a video display unit 1310 (e.g., a liquid crystal display (LCD) or a cathode ray tube (CRT)), an alphanumeric input device 1312 (e.g., a keyboard), a cursor control device 1314 (e.g., a mouse), and a signal generation device 1316 (e.g., a speaker).

Data storage device 1318 may include a machine-readable storage medium (or more specifically a computer-readable storage medium) 1328 having one or more sets of instructions (e.g., software 1322) embodying any one or more of the methodologies or functions described herein. For example, software 1322 may store instructions for managing a trust. Software 1322 may also reside, completely or at least partially, within main memory 1304 and/or within processing device 1302 during execution thereof by computer system 1300; main memory 1304 and processing device 1302 also constituting machine-readable storage media. Software 1322 may further be transmitted or received over a network 1320 via network interface device 1308.

Machine-readable storage medium 1328 may also be used to store instructions for managing a trust. While machine-readable storage medium 1328 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

Whereas many alterations and modifications of the present invention will no doubt become apparent to a person of ordinary skill in the art after having read the foregoing description, it is to be understood that any particular embodiment described and shown by way of illustration is in no way intended to be considered limiting. Therefore, references to details of various embodiments are not intended to limit the scope of the claims, which in themselves recite only those features regarded as the invention.

What is claimed is:

1. A computer implemented method, comprising:
receiving, at a processing device, literacy metrics for a plurality of authors, the literacy metrics received for each author based on multiple revisions of a document associated with the plurality of authors;
analyzing, by the processing device, the multiple revisions to identify interactions between the plurality of authors; and
generating, by the processing device, a collaboration graph displaying the interactions between the plurality of authors.

2. The method of claim 1, wherein the literacy metrics comprise document sophistication values, and wherein the collaboration graph displays changes of the document sophistication values for each revision of the multiple revisions.

3. The method of claim 1, wherein the literacy metrics comprise document sophistication values, and wherein the collaboration graph displays changes of the document sophistication values for each author of the plurality of authors.

4. The method of claim 1, wherein the multiple revisions occur during a predetermined duration of time, the predetermined duration of time being a semester.

5. The method of claim 1, wherein the collaboration graph comprises a chord diagram displaying the literacy metrics of the plurality of authors.

6. The method of claim 1, wherein the collaboration graph includes nodes and arcs, each node representing an author of the plurality of authors and each arc representing the interactions between the plurality of authors.

7. The method of claim 1, wherein the interactions between the plurality of authors are identified during a modification of the document.

8. A computer system comprising:
a memory; and
a processing device communicatively coupled to said memory, said processing device configured to:
receive, at a processing device, literacy metrics for a plurality of authors, the literacy metrics received for each author based on multiple revisions of a document associated with the plurality of authors;
analyze, by the processing device, the multiple revisions to identify interactions between the plurality of authors; and
generate, by the processing device, a collaboration graph displaying the interactions between the plurality of authors.

9. A non-transitory computer-readable storage medium programmed to include instructions that, when executed by a processing device, cause the processing device to perform a method, said method comprising:
receiving, at a processing device, literacy metrics for a plurality of authors, the literacy metrics received for each author based on multiple revisions of a document associated with the plurality of authors;
analyzing, by the processing device, the multiple revisions to identify interactions between the plurality of authors; and
generating, by the processing device, a collaboration graph displaying the interactions between the plurality of authors.
